(19) United States
(12) Patent Application Publication
(10) Pub. No.: US 2020/0287619 A1
(43) Pub. Date: Sep. 10, 2020

(54) SYSTEM AND METHOD FOR CONTROLLING A PILOTLESS DEVICE

(71) Applicant: FLYLOGIX LIMITED, Hampshire (GB)

(72) Inventors: Charles TAVNER, Hampshire (GB); MIchael PERRETT, Hampshire (GB); Raivis STROGONOVS, Hamshire (GB)

(21) Appl. No.: 16/648,870

(22) PCT Filed: Sep. 19, 2018
(86) PCT No.: PCT/GB2018/052676

§ 371 Date: Mar. 19, 2020

(30) Foreign Application Priority Data
Sep. 19, 2017 (GB) 1715123.4

(51) Int. Cl. H04B 7/185; G05D 1/00; G01S 19/42; G05D 1/10; B64C 39/02

(52) U.S. Cl. CPC H04B 7/18508; G05D 1/0022; G01S 19/42; B64C 2201/146; B64C 39/024; B64C 2201/021; G05D 1/101

(57) ABSTRACT

A method of, or system for, controlling a pilotless device, uses independent data links that provide multiple, redundant data channels. First, a direct radio link with a ground control station is used to receive command signals that enable a pilot to issue commands to an autopilot in the device, or to directly control the device. Secondly, there is an indirect control link with the ground control station, via satellites, that is used to send command signals to the device and to send back flight information and position data from a GPS or other satellite-based position receiver in the device. Thirdly, there is an indirect position data link back to the ground control station, via low earth orbit satellites, that is used to send back position data from a different GPS or other satellite-based position receiver in the device.

### BACKGROUND OF THE INVENTION

### 1. Field of the Invention

The field of the invention relates to a system and method for controlling a pilotless device, such as a remotely piloted aircraft.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

In recent years, remotely Piloted Aircrafts (RPA) such as drones equipped with cameras, have been increasingly used in a wide array of applications, such as area surveillance or damage inspection.

Pilotless devices are normally controlled manually by a pilot using a remote control device, keeping the device within a line of sight. The pilot is able to send commands to the device via a wireless communication link, typically a 2.4 Ghz or 28 GHz radio link. The typical maximum range is no more than 7 Km.

There is a need for improved methods for reliably controlling a pilotless device for long distance that greatly exceed the line of sight—such as 50 Km or longer.

### SUMMARY OF THE INVENTION

A method of, or system for, controlling a pilotless device, uses independent data links that provide multiple, redundant data channels. First, a direct radio link with a ground control station is used to receive command signals that enable a pilot to issue commands to directly control the device or through an autopilot in the device. Secondly, there is an indirect control link with the ground control station, via satellites, such as low earth orbit satellites, that is used to send command signals to the device and to send back flight information and position data from a GPS or other satellite-based position receiver in the device. Thirdly, there is an indirect position data link back to the ground control station, via satellites, such as low earth orbit satellites, that is used to send back position data from a different GPS or other satellite-based position receiver in the device.

### BRIEF DESCRIPTION OF THE FIGURES

Aspects of the invention will now be described, by way of example(s), with reference to the following Figures, which each show features of the invention:

FIG. 1 shows a diagram of a system for controlling a Remotely Piloted Aircraft via independent data links.

FIG. 2 shows a diagram of a segregated airspace corridor.

FIG. 3 shows a dynamic representation of the location of the RPA.

FIG. 4 shows a diagram of a ground control station.

FIG. 5 shows a diagram of the key components of the system.

### DETAILED DESCRIPTION

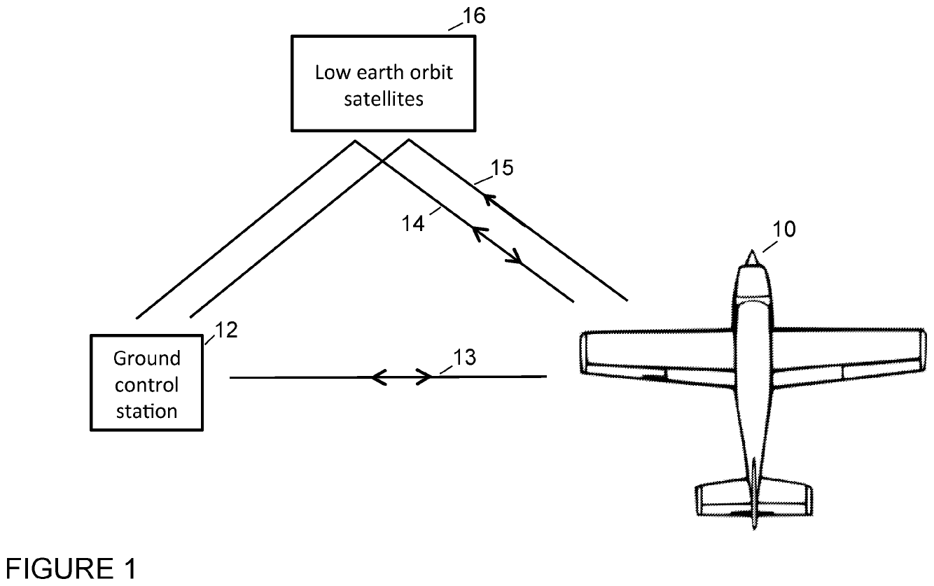

With reference to FIG. 1, a pilotless device 10, such as a Remotely Piloted Aircraft (RPA) is controlled from a ground control station 12 where a pilot can establish direct radio communication with local air traffic control. The RPA 10 is controlled via independent data links providing multiple redundant data channels.

The RPA 10 receives command signals via a direct radio link 13 from the ground control station, enabling a pilot to send instructions to the auto-pilot in the RPA 10 and, if the RPA 10 is within the line of sight, then to have direct flight control over the RPA. The pilot is able to switch the RPA between different states at any stage during the operation, such as: continue on planned route, return to home or ditch. This is possible due to the latency of the radio link being very low, such as 0.1 second.

The direct radio link is an encrypted link, independent of internet for security of operation. It may be a UHF radio link that is operable beyond line of sight by bouncing signals off the F1, F2 layers and sea.

Key features of the ground control station 12 and the direct radio link 13 that enable the flight range of the RPA 10 to be maximises, include, but are not limited to, the following.
Aerials are mounted on a tower to maximise height and minimise ground interference.
Diversity switching is provided by two receiver aerials on the RPA to maximise signal quality.
Launch aerial arrangements maximise range. For example, circular polarised aerials (to avoid loss of signal during bank) or yagi aerials are used. These can be arranged as doubles or quads to further enhance performance.
Amplifier and pre-amplifier are designed to maximise launch power.

An indirect control link 14 via low earth orbit satellites 16, enables the RPA to also receive command signals from the ground control station and to send position data from a GPS inside the RPA back to the ground control station. Additionally, the RPA may also send flight information data, such as engine data and artificial horizon data, back to the ground station.

Alternatively, the command signals can also be received from a different ground control station or from a control center.

The indirect control link 14 includes the following features:
It cannot override the direct command link 13.
The link is encrypted.
The link provides primary position information from an integrated GPS unit in RPA 10.
Information is fed via the internet, from satellite receiving stations that are in communication with the low earth orbit satellites 16, to a device such as a computer, laptop or smartphone at a ground control station.

Hence, whilst the device is sufficiently close to permit real-time control, the direct radio link 13 enables direct control of the RPA 10 from a pilot on the ground. And if the device is not sufficiently close, the indirect control link 14 enables indirect control by sending commands to an autopilot on the RPA 10. In the case where communications from the ground control station 12 to the RPA 10 cease operating, the autopilot can also continue to operate the RPA 10. The autopilot is configured to autonomously cease its planned operation if it determines that it has exceeded a predetermined period of time or is likely to enter a restricted area or otherwise constitute a hazard or danger.

Low earth orbit satellites 16 (such as Iridium or Globalstar) enable low power requirements and smaller, non-steerable, aerials in the RPA 10. Less weight is therefore required on the RPA 10. The system has sufficient bandwidth to be able to alter a flight plan loaded into an autopilot located on the RPA 10. Hence a mission and its flight plan may be dynamically adjusted using indirect control link 14. This is a link that operates independently to direct command link 13.

Before the start of a mission, the autopilot is loaded with the following: flight plan, perimeter of the specified block of airspace (area & altitude), home location for safe return, automatic ditch sequence. The indirect control link 14 can update the flight plan on the autopilot at anytime. It can also update the safe return position.

An indirect position data link 15 enables the RPA 10 to send supplementary or additional position data from a different GPS inside the RPA 10 back to the ground control station 12 via low earth orbit satellites 16.

The indirect position data link 15 utilizes components on the RPA that are isolated from the components used to provide the indirect control link 14. This, in turns provides the system with double positional data redundancy, with position data coming back from the indirect control link 14 and also the indirect position data link 15. Triple positional data redundancy is possible if position data is also sent back from the RPA 10 over the direct radio link.

The indirect position link 15 has the following features:
Short burst low earth orbit satellite link (Iridium or Globalstar).
Very low bandwidth and short burst dial up protocol maximises availability (average every 10 s).
It uses its own GPS and battery supply on the RPA 10 to ensure complete independence from the primary position information sent over indirect control link 14.
Information is fed, via the internet, from satellite receiving stations that are in communication with the low earth orbit satellites 16, to separate computers at the or each Ground Control Station.
As it is short burst, it typically selects a different satellite from the main control link even when using the same network as it seeks the strongest signal in that instant, rather than trying to retain the satellite it has been communicating with for some time.

At any time, in normal operation, there are two independent uplinks to the device, namely the direct radio link 13 and the indirect control link 14; and there are two independent downlinks, namely the indirect control link 14 and the indirect position data link 15, each providing redundancy for enhanced safety.

Key features of the system's architecture are, but not limited to, the following.
The command link 13 is at the top of hierarchy and can immediately tell the RPA what to do at all times.

The control and position links 14, 15 provide two completely independent methods of verifying the RPA is within the segregated airspace or in the location expected. They use different GPS signals, different LEO protocols and different power supplies.
A buffer zone (described in detail below) ensures the system is tolerant to latency and temporary drop out of both LEO satellite communications and their position data.
The flight planning is supported by software analysing daily NORAD satellite data to predict periods with poor satellite visibility and predict longer periods of satellite drop out.

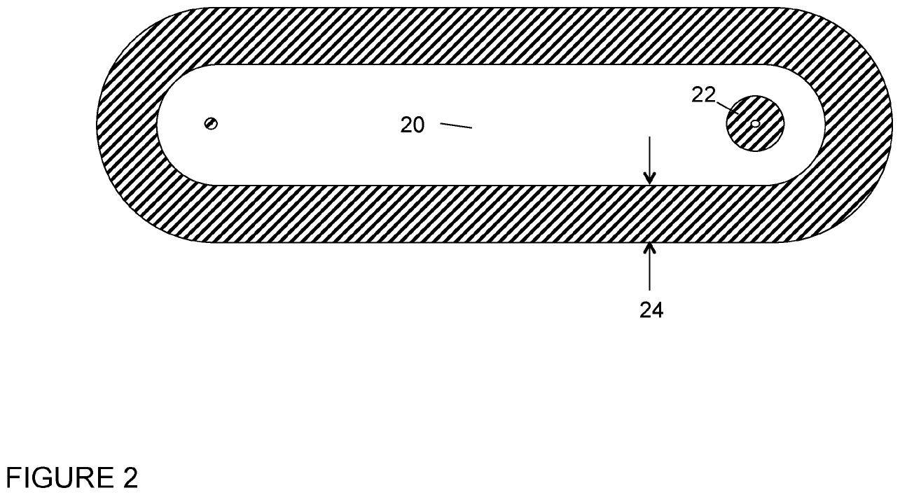

With reference to FIG. 2, a geofenced route 20 defines a specific block of airspace (area and altitude) in which the RPA should be kept inside until it reaches an offshore point 22. A larger area of segregated airspace corridor is established by creating an additional ‘buffer zone’ 24. As an example, the segregated airspace corridor is 1000 feet up and 2 miles wide.

As establishing a segregated airspace for every mission over the full distance of the mission is unattractive, an hybrid approach is used where the aircraft flies for part of the mission outside segregated airspace in more remote areas using an approach similar to an Instrument Flight Rules (IFR) operation. The RPA includes or is controlled by safety systems that constrain its movements to within the segregated airspace corridor until it reaches the offshore point, where the segregated airspace corridor ends. Therefore, once the RPA reaches the offshore point, it changes to IFR and operates in open airspace.

The RPA is fitted with an ADSB transponder. Once beyond the area of segregated airspace, ATC (Air Traffic Control) provides deconfliction.

The segregated airspace corridor ensures safety of civilian aircraft in less remote areas with limited awareness of other aircraft in their vicinity, and in particular no ability to detect a transponding aircraft, such as hot air balloons and para-gliders.

The segregated airspace corridor also ensures safety of third parties on the ground by ensuring flight path avoids overflying critical installations and limited, remote, onshore transitions from airfield to over the sea.

The ‘buffer zone’ 24 is defined by the latency of the positional communication system and the speed of the aircraft. It is configured to ensure that the RPA never leaves the area of segregated airspace. Exceeding the duration permitted for loss of contact, established by the buffer zone, may end in ditching the aircraft within the segregated airspace (eg by sending a signal to the autopilot in the device over command link 14 to immediately ditch).

The RPA operates below a ceiling that other air users would not routinely operate in. This minimizes the impact of segregated airspace identified by NOTAM (A Notice to Airmen) with a detailed flight plan.

A fixed segregated airspace corridor can also be established for a particular airfield.

The offshore point may be a ‘return to home’ point. Alternatively, the offshore point may also be sufficiently out to sea that normal air traffic in that area is of the type that can detect a transponder used by the device, making a segregated airspace corridor beyond that point unnecessary.

Establishing a workable altitude buffer zone may prove more difficult depending on the mission. For example, the typical vertical separation between the RPA and helicopters may be as little as 1,000 ft (helicopters routinely operate at 2,000 ft and we want 1,000 ft ceiling). Hence, in addition to geofencing a specified block of airspace (area & altitude), the system may also:
limit the maximum rate of climb to [1,000 ft per minute];
report barometric altitude more frequently via SBD;
use barometric altitude to provide a cap on autopilot.

The buffer zone is not necessarily fixed and may also be dynamically updated.

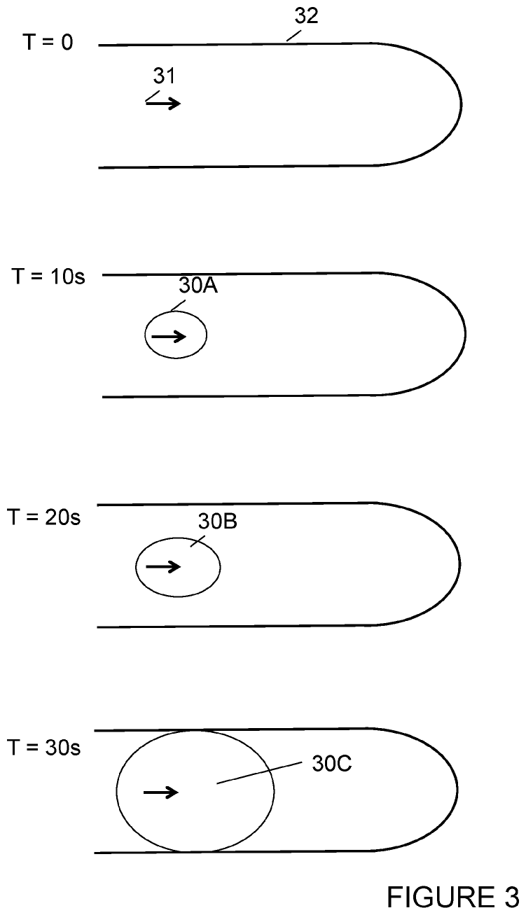

With reference to FIG. 3, a control system plots and displays a dynamic probabilistic representation 30A, 30B, 30C of where the RPA 31 could be following the temporary interruption of communication, taking into account variables such as: last known speed, last known heading, last known or maximum rate of turning, last known acceleration or deceleration, position signal latency, position signal uncertainty, or last known position.

A flight zone 32 is defined as the region or area the RPA must remain in. The control system starts to plot and display the dynamic representation once all position signals from the device have been lost. The dynamic representation is a probabilistic model of where the device could be at one or more times in the future and may represent a growing tear drop 30A, 30B, 30C. A pilot monitoring the display can rapidly assess if the dynamic representation is likely to, or has, exceeded the boundary of the flight zone area.

The control system or pilot then determines if the RPA dynamic representation intersects the boundary of a flight zone 32, and if it does, e.g. at T=30 seconds, when the tear drop 30C intersects the boundary of the flight zone 32, the control system or pilot sends an immediate abort signal to the RPA. Alternatively, the control system or the pilot may send a return to base signal, or another signal to minimize risk, to the RPA.

The dynamic representation is plotted out for a time in the future that is sufficient to enable an abort or return to home message to be sent, received and acted on by the RPA before it moves beyond the flight zone.

A network of fixed or mobile ground control stations is established for the command link and ATC (Air Traffic Control) communications.

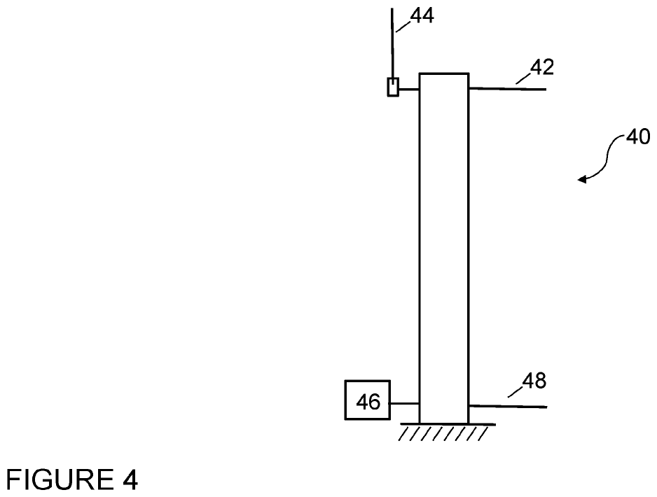

With reference to FIG. 4, each ground control station (GCS) 40 has a UHF transceiver 42 and aerial 44, an uninterruptable power supply 46 and a data link 48 to one or more control centres to enable a pilot at any control centre, anywhere in the world, to have flight control over the device by, e.g. sending signals to the autopilot in the device.

The UHF may need to be steerable or to have duplicates, as its normal field is +/−15 degrees and the required mission arc may be larger.

The UHF transceiver 42 is a steerable UHF aerial that is used for the direct command link with the RPA and the aerial 44 is used for ATC communication and camera or cameras for visualizing the aircraft when in visual site to aide landing and take off.

The ATC communication, via aerial 44, uses repeaters to enable communication with ATC beyond 80 miles when frequency switches.

The ground control centre may also function as a control centre. The control centre may send and receive data to the RPA via the data link 48 using an internet or other data connection to one or more satellite ground stations that send data to and receive data from the low earth orbit satellites.

The network of ground control stations is arranged to provide a set of nodes that cover all or substantially all of an area from which the device is likely to fly from. As an example, an area covers a region from The Northern, Central and Southern North Sea. An area of the size of the United Kingdom is served by a network of approximately 10 to 30, or preferably 20 ground control stations.

Larger range operations can be supported with similar command stations strategically placed offshore. Very large areas, both onshore and offshore, can be supported by a grid of these low-cost base stations (like cell towers). The indirect control and position links are unaffected as they are already internet based.

To re-cap, in an implementation, the pilot and safety officer fly the aircraft from a single control centre. The satellite links can all be connected to this control centre. However the radio link needs a local station near the aircraft. This would typically be where it takes off from but does not need to be. Therefore we need these remote masts that are tied back via internet to the single control centre to have a direct radio link to aircraft along with a radio link to local ATC on the correct local channels. These masts can then be arranged as nodes and create a network of direct, low latency, radio links to the aircraft. The existence of this low latency direct link to the aircraft is critical to safety case.

A customer located remotely may be given a read only access to the control and position links via a URL to enable them to follow and provide input into the operation from an external location, such as an office.

The processing on board the RPA of either flight data or customer data is maximised to provide information rather than raw data and minimise the continuous data transfer required. However, the system may also connect to local high bandwidth (4G) networks offshore for increasing data transfer for 2 purposes:
One way: streaming live imagery from a camera on the device providing a FPV (first person view) direct to the customer's office to improve the value of the operation;
Two way: stream live imagery and provide short latency control of the RPA to the pilots at one or more control centre to enable closer work or direct control during landing to be conducted.

An RPA may fly with multiple payloads, such as, but not limited to:
Optical Gas Imaging Camera for remote qualitative measure of gas levels;
Multispectral camera for remote quantitive gas levels;
Laser gas detection for direct gas measurement in the air,
Visual camera for asset integrity work.

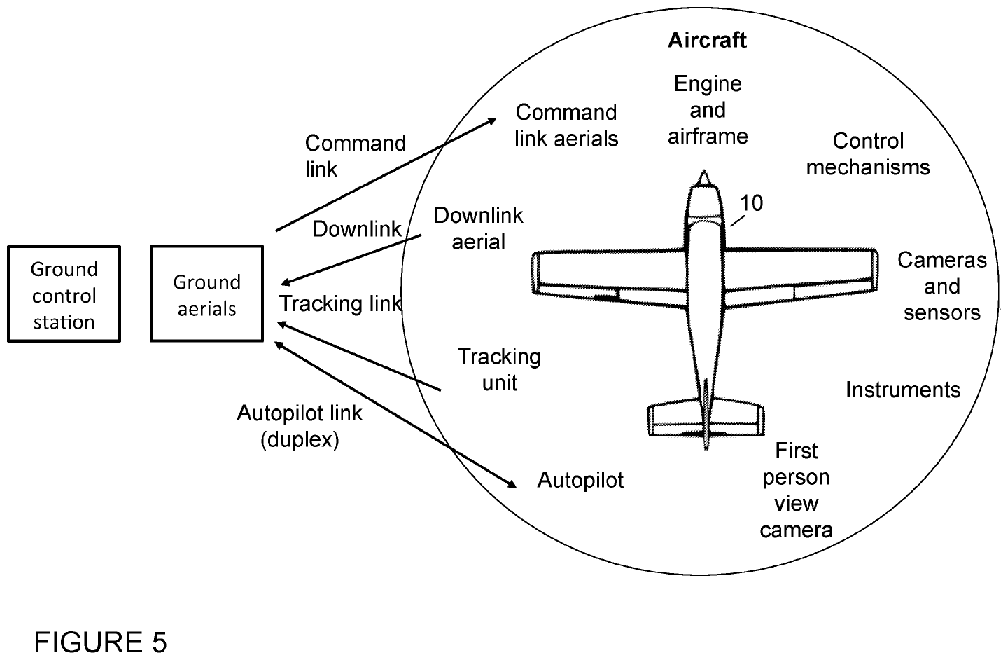

With reference to FIG. 5, a diagram with a more detailed description of the components of the system for controlling an aircraft 10 is shown. The components of an implementation of the system are described in detail in the following sections.

### Ground Control Station

The GCS equipment is based in a van and moveable to different locations. The pilot(s) use an extensively modified handset to control the aircraft in “Manual” flight. The plane is taken off visually and once airborne handed over to the BVLOS (beyond visual line of sight) pilot who is stationed in the Master GCS or control centre. The Master GCS is located in a vehicle where the BVLOS Pilot is able to view a real time “cockpit” which is transmitted down to the Master GCS.

The aircraft is controlled from a handset and the pilot(s) can switch between these at anytime. In comparison, current solutions often use an aircraft that is locked onto a single handset. The system allows the aircraft to be taken-off by the local Slave GCS Pilot and then flown at the same or a different location by the BVLOS pilot. If required another Slave GCS pilot can take visual control of the aircraft and land the aircraft at a distant location. As an example, up to 2,048 handsets can be used.

The pilot operates the autopilot and monitors the position of the aircraft. They are supported by a safety officer who continually monitors the progress of the flight to ensure that the aircraft is operated within the parameters specified in the flight plan and safety manual. The Pilot and Safety Officer are typically in same place, but one could be located at the launch site and one at the head office. Note the safety officer information is already all provided over internet based systems, so can be done without the remote mast.

The van has uninterruptable power with 5 sources of power (generator, alternator, batteries, UPS). The FPV (First Person View) may either be removed and the plane flown off autopilot once beyond line of sight. Alternatively, the range can be increased.

Ground Aerials

A high gain circular polarised UHF antenna is used to provide the command “up-link” to the aircraft. This ensures that the aircraft receives the same signal strength irrespective of the orientation of the aircraft with respect to the transmitter station. If transmitting a First Person View, then the downlink ground aerials are typically also circular polarised high gain antenna's coupled with high gain mast mounted pre-amplifiers to boost the received signal strength.

A bespoke Video Diversity Switching Unit (VSDU) is used in conjunction with the downlink antenna system to allow switching between the twin video links and the FPV display screen. The design is unique and provides the best possible video display image to the pilot.

The autopilot aerial is off the shelf and linked to a 868 MHz modem. The tracking link doesn't have an aerial but receives data from a server over the internet. The aerials are mounted on a hydraulic mast to increase range. Alternatively, the downlink aerials may be removed. The autopilot aerial may be replaced with, or complemented by satellite modem. The mast may also be made integral to the van.

The Command Link

The Command link is a 433 MHz UHF signal—using Pulse Width Modulation (PWM). The Command link transmits the signals for the control surfaces and throttle when the aircraft is being piloted manually. The Command link changes the mode of the autopilot (return to home/manual/assisted/auto).

If the Command link is lost then the aircraft can be pre-configured to enter a number of Safety modes—currently to automatically ditch after a set period. This is vital to preventing “flyaway” where an aircraft on autopilot flies beyond its range of control. With the Command link being a VHF link if it is lost or turned off at any stage then the aircraft will enter a safety mode. The received signal strength of the Command link at the aircraft is sent back to the GCS (currently by the downlink). The power of the Command link may also be increased to give a greater range.

The Downlink

The aircraft use twin “Downlinks” at various frequencies within the 1.3 GHz UHF (23 cm) band. The downlink transmits the video image from the First Person View (FPV) camera. The FPV image includes information such as the virtual horizon, airspeed, received signal strength and position.

Alternatively, the downlink may be removed or upgraded to provide a video image from a stabilised steerable thermal/video camera.

The Tracking Link

The Tracking link is a satellite connection over the Iridium network or similar. The link sends the position of the aircraft to a server. Alternatively, the tracking link may also directly link a modem on the plane to a modem at the GCS to reduce the latency of the system. The Tracking link may also use a different satellite network than the autopilot link to increase redundancy.

The Autopilot Link
The Autopilot link is a duplex 868 MHz UHF link.
Waypoints are uploaded before each “mission”, however the system has the capability to upload or move existing waypoints over the autopilot link during the “mission”.
The link sends down flight information, such as position, speed, virtual horizon.

The autopilot link may also include the following features:
The autopilot link may also be complemented by a duplex satellite link between the GCS and the aircraft sending the same information.
The 868 MHz link may be used over short range and may switch to the satellite over longer range.
This dual control may also create some resilience to interference and solar flares.
Received signal strength may be added to the autopilot link.
The autopilot link may use a different satellite network to the tracking link to increase redundancy.

The Command Link Aerial

A pair of bespoke circular polarised helix aerials, mounted at 90 degrees on the aircraft receiving 70 cm “Command” signals on different channels is used.

Downlink Aerial

A pair of “clover-leaf” or “V-aerials” mounted at 90 degrees on the aircraft and broadcasting on different channels with the 23 cm band.

Alternatively, the aerials may be removed if the downlink is removed or replaced with a satellite link to increase range.

Tracking Unit

The unit is a commercially available tracker which broadcasts the position every 15 seconds. The tracking unit has an internal battery and is independent of the rest of the plane.

The tracking unit may also include the following features:
The unit may be replaced by a bespoke satellite modem and a GPS chip.
The GPS chip may be different to all the others onboard to add redundancy and reduce systematic errors.
The satellite modem may use a different network than the autopilot link to add redundancy.
The unit may have its own battery.

Autopilot

The autopilot is mounted on a bespoke isolation board suspended by hydraulic dampers which can be tuned to take vibration.

The GPS chip may also be different to all the others onboard to add redundancy and reduce systematic errors. A satellite modem may be added for the autopilot link (different network to the tracking link).

Engine and Airframe
The airframe is an off the shelf aircraft.
The engine is a standard 2 stroke petrol engine.
Wing tanks have been developed, which while common in full size aviation are believed to be unique in UAVs.
The aircraft is carefully designed to reduce radio interference with twisted cables and an optical isolation unit.
There is careful thought to redundancy—e.g. two servos on the elevators.

Alternatively, the airframe may be developed to reduce drag and increase range. The engine may also be changed for a 4 stroke and at some point the aircraft may be electrified.

Control Mechanisms

The control surfaces are redundant.

Cameras and Sensore

An infra-red camera that records to a memory card is mounted on the aircraft looking down and forward to observe oil and gas platforms for leaks. The camera can be used for other applications such as search and rescue, security or checking pipelines. Other instruments can be mounted including, but not limited to: cameras, gas sniffers, thermometers, humidity sensors, LIDAR. The UAV can therefore be used for a wide range of applications, including: search and rescue mission, delivery service, area surveillance or inspection, meteorology, volcano observation. The images or readings may be sent back from the aircraft to the GCS by a separate link. The camera may be mounted on a gimbal and controllable from the ground or set to focus on a particular location(s).

Instruments

A number of off the shelf instruments on the aircraft are used to help control the aircraft, such as a pitot-static tube for airspeed.

First Person View Camera

A camera mounted under the canopy in the “cockpit” of the aircraft looking forward is used. This records what a pilot would see. A FPV unit (off the shelf) overlays a virtual horizon, and instrument data including position and ground speed to this image before it is sent back to the GCS over the Downlink.

Regulation
Situational awareness:
   This is done by flying in a “temporary or permanent danger area” where other aircraft should not be operating.
   The danger area is segmented and different areas are opened or closed depending on where the aircraft is. For example, an area over the airfield is used for take off/landing, an area is used for covering the approach to the airfield and a corridor to the platform/destination is established.
Positional awareness
   This is done via the autopilot and tracking unit which are independent (different networks, separate power, different GPS chips).
Control
   A dedicated pilot that can step in at any point during a mission is used, even on autopilot.
   The Command link alone is always able make the aircraft return to home. If this is lost then after a preset period the aircraft may ditch in the sea.
   If other links are lost then the aircraft returns to home under autopilot.

Alternatively, the following features may be used:
An offshore platform 3G, 4G or proprietary base station may be used to allow control of aircraft or data download.
Network of communication nodes may be established on platforms (or ultimately across the country) with minimum space to enable national coverage and full authority flying of a drone between.
Use of nationwide network of base stations to provide communications and recharge points to allow a drone with a 100 mile range to transit over much greater distances by rapidly stopping at nodes, recharging/refuelling and taking off again.
Use of coastline or inland water ways as low risk corridor for transiting around the country whilst minimising risk to third parties.
Distributed power along full length of the wing (probably electric) to create blown wing enabling penetration and efficient long distance transit to an offshore facility and then low speed manoeuvring to either operate very close to an offshore structure to obtain imagery or land on the restricted runway of a helideck.

Electrification

An electric fixed wing aircraft may also be used, such as a blown wing. As the aircraft may predominantly be used for maritime operations a majority of the batteries may be mounted in an droppable pod. This would allow the aircraft to “dump” the dead weight of the exhausted batteries and fly back with a more efficient wing loading using the remaining “internal” batteries. The internal batteries would be protected by blocking diodes so they are always fully charged and are only selected when the external batteries are closed to exhaustion.

A “modular” airframe in which the power pod can be replaced may also be used. For shorter noise sensitive flights electrical power is used and for longer less noise sensitive flights we can switch to a gas engine. Additionally replaceable wings may be used for different missions. For example: low aspect ratio/heavy wing loading for use in windy conditions and higher aspect ratios/lower wing loading of use on longer flights in calmer conditions. A hybrid aircraft may also be used where the internal combustion engine is sized for steady flight and the batteries are used for take off, extra power and landing. The batteries are charged by the ICE and additionally by the propellers freewheeling.

Remotely Stored and Operated Aircraft

An aircraft is permanently stored in a secure weather proof box (base station) in a remote location. The aircraft is electrically powered fixed wing, helicopter or multi rotor helicopter (e.g. octocopter or quadcopter). The base station either has an external power supply or its own solar panel and battery, and may have a high bandwidth connection to the control centre where the pilot controls the aircraft from. The base station may have an anemometer and camera so the remote pilot can observe the conditions at the base station. The base station is remotely opened using a radio, satellite link, or the higher bandwidth connection.

Once the base station is opened the aircraft is piloted from the control centre. It takes off (directly from the box if VTOL or from a short runway if fixed wing) and may follow pre-learnt inspection route, under autopilot, or be manually piloted. In flight the connection from the control centre to the aircraft may go over the high bandwidth connection to the box and then to the aircraft using radio—or directly to the aircraft using satellite and radio. The aircraft carries inspection equipment (including cameras and gas sniffers) and may send information directly back to the control centre or store it onboard to send back when landed.

At the end of the mission the aircraft lands and enters the base station and the base station is sealed again. The aircraft is then charged using an induction charger, and images and other data are downloaded to the box using wifi and then sent back over connection the to the control centre. The charge state and battery health of the aircraft are reported to the control centre. A number of base stations may be set up along a large asset, such as a pipeline, and each aircraft take off from one base station and land at the next one, such that the whole asset is overflown.

### APPENDIX 1: KEY FEATURES

This section summarises the most important high-level features (A->D); an implementation of the invention may include one or more of these high-level features, or any combination of any of these. Note that each high-level feature is therefore potentially a stand-alone invention and may be combined with any one or more other high-level feature or features or any of the ‘optional’ features; the actual invention defined in this particular specification is however defined by the appended claims.

A. Triple Link

Method of controlling a pilotless device, such as a RPA, in which the device uses the following independent data links that provide multiple, redundant data channels:
(a) a direct radio link with a ground control station, to receive command signals that enable a pilot to issue commands to an autopilot in the device or have direct flight control over the device;
(b) an indirect control link with the ground control station, a different ground control station or another form of control centre, the control link being via satellites, such as low earth orbit satellites, and being used to send command signals to the device and to send back flight information and position data from a GPS or other satellite-based position receiver in the device;
(c) an indirect position data link back to the control centre(s), the position link being via satellites, such as low earth orbit satellites, and being used to send back position data from a GPS or other satellite-based position receiver in the device.

System for controlling a pilotless device, such as a RPA, in which the system uses the following independent data links that provide multiple, redundant data channels:
(a) a direct radio link with a ground control station, to receive command signals that enable a pilot to issue commands to an autopilot in the device or have direct flight control over the device;
(b) an indirect control link with the ground control station, a different ground control station or another form of control centre, the control link being via satellites, such as low earth orbit satellites, and being used to send command signals to the device and to send back flight information and position data from a GPS or other satellite-based position receiver in the device;
(c) an indirect position data link back to the control centre(s), the position link being via satellites, such as low earth orbit satellites, and being used to send position data from a GPS or other satellite-based position receiver in the device.

Optional features in an implementation of the invention include any one or more of the following:
The direct radio link is a UHF radio link
The direct radio link enables direct control of the device from a pilot on the ground, whilst the device is sufficiently close to permit real-time control, and limited, indirect control by sending commands to an autopilot on the device, if the device is not sufficiently close.
The indirect control link back to the ground station includes flight data from the device, such as engine data and artificial horizon data
The indirect position data link back to the ground control station utilizes components on the device that are isolated from the components used to provide the indirect control link.
The GPS or other satellite-based position receiver that provides position data sent over the indirect control link is separate and independent from the GPS or other satellite-based position receiver that provides position data sent over the indirect position link.
At any time, in normal operation, there are two independent uplinks to the device, namely the direct radio link and the indirect control link; and there are two independent downlinks, namely the indirect control link and the indirect position data link, each providing redundancy for enhanced safety.
The device includes an autopilot that can continue to operate the device even if communications on all uplinks to the device cease operating.
The device includes an autopilot that can continue to operate the device even if communications on all uplinks to the device cease operating, and is configured to autonomously cease its planned operation if it determines that it has exceeded a predetermined period of time or is likely to enter a restricted area or otherwise constitute a hazard or danger.
The or each ground control station includes an antenna
The or each ground control station functions also as a control centre where one or more pilots are based.
One or more ground control station functions do not operate as a control centre where one or more pilots are based.
One or more control centres send and receive data to the device using an internet or other data connection to one or more satellite ground stations that send data to and receive data from the low earth orbit satellites.

B. Hybrid Segregation

Method of, or system for, operating a pilotless device, such as a RPA, in which a segregated airspace corridor is established around an airfield or other take-off zone and to an offshore point; where operation of the device changes to IFR (Instrument Flight Rules) when the device reaches the offshore point and operates in open airspace.

Optional features in an implementation of the invention include any one or more of the following:
The offshore point is a ‘return to home’ point
The offshore point is sufficiently out to sea that normal air traffic in that area is of the type that can detect a transponder used by the device, making a segregated airspace corridor unnecessary.
The device includes or is controlled by safety systems that constrain its movements to within the segregated airspace corridor until it reaches the offshore point, where the segregated airspace corridor ends.
segregated airspace corridor is for example 1000 feet up and 2 miles wide
segregated airspace corridor ensures safety of civilian aircraft with limited awareness of other aircraft in their vicinity, and in particular no ability to detect a transponding aircraft, such as hot air balloons and para-gliders.

C. Dynamic Buffer

Method of, or system for, operating a pilotless device, such as a RPA, in which a control system plots and displays a dynamic representation of where the device could be, taking into account variables such as last known speed, last known heading, last known or maximum rate of turning, last known acceleration or deceleration, position signal latency, position signal uncertainty, data drops or interruptions; where the control system starts to plot and display the dynamic representation once all position signals from the device have been lost.

Optional features in an implementation of the invention include any one or more of the following:
a flight zone is input to the control system, or defined by that control system, the flight zone specifying an area or region the device must remain in, and the dynamic representation enables a pilot or automated process to determine if the dynamic representation is likely to intersect the boundary of the flight zone.
The flight zone is displayed together with the dynamic representation to enable a pilot to rapidly visually assess if the dynamic representation is likely to intersect the boundary of the flight zone.
Where the pilot or the control system determines that the dynamic representation is likely to intersect the boundary of the flight zone, then the pilot or the control system sends an abort signal, or a return to base signal, or another signal to minimize risk, to the device.
The dynamic representation is a probabilistic model of where the device could be, taking into account variables such as last known speed, last known heading, last known or maximum rate of turning, last known acceleration or deceleration, position signal latency, position signal uncertainty, data drops or interruptions.
The dynamic representation is tear-drop or elliptical shape
The dynamic representation is tear-drop or elliptical shape that expands or extends in length over time so long as the lack of any positioning signals from the device continues
The dynamic representation is plotted out for a time in the future that is sufficient to enable an abort or return to home message to be sent, received and acted on by the device before it moves beyond the flight zone.
A display shows the dynamic representation and the flight zone, so that a pilot monitoring the display can rapidly assess if the dynamic representation is likely to, or has, exceeded the boundary of the flight zone area.

D. Network of Ground Stations

Method of, or system for, controlling a pilotless device, such as a RPA, in which the device uses a direct radio link with a network of ground control stations, to receive flight command signals; and in which each ground control station has a UHF transceiver and aerial, an uninterruptable power supply and a data link sub-system to provide the direct data link to the device.

Optional features in an implementation of the invention include any one or more of the following:
The direct radio link enables direct control of the device from a pilot on the ground, by sending commands to an autopilot on the device
The direct radio link enables direct control of the device from a pilot on the ground, whilst the device is sufficiently close to permit real-time line of sight control.
The network of ground control stations is arranged to provide a set of nodes that cover all or substantially all of an area from which the device is likely to fly from.
An area of the size of the United Kingdom is served by a network of approximately 10 to 30, or preferably 20, ground control stations.
The ground control stations provide a UHF link to the devices.
The or each ground control station functions also as a control centre where one or more pilots are based.
One or more ground control station functions do not operate as a control centre where one or more pilots are based.
The control centres provide multiple redundant data links to the device using (a) an indirect control link via low earth orbit satellites, that carry command signals from the control centres and position data from a GPS or other satellite-based position receiver in the device, and (b) an indirect position data link via low earth orbit satellites, to carry position data from a separate, additional GPS or other satellite-based position receiver in the device.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A method for controlling a pilotless device, such as a RPA, in which the device is configured to use the following independent data links that provide multiple, redundant data channels:
(a) a direct radio link with a ground control station, configured to receive command signals that enable a pilot to issue commands to an autopilot in the device or have direct flight control over the device;
(b) an indirect control link with the ground control station, a different ground control station or another form of control centre, the control link being via satellites, such as low earth orbit satellites, and being configured to send command signals to the device and to send back flight information and position data from a GPS or other satellite-based position receiver in the device;
(c) an indirect position data link back to the control centre(s), the position link being via satellites, such as low earth orbit satellites, and being configured to send position data from a GPS or other satellite-based position receiver in the device;
and in which the device includes an autopilot that can continue to operate the device even if communications on all uplinks, namely the direct radio link and the indirect control link, to the device cease operating.

2. The method of claim 1, in which the direct radio link is a UHF radio link.

3. The method of claim 1, in which the direct radio link enables direct control of the device from a pilot on the ground, whilst the device is sufficiently close to permit real-time control, and limited, indirect control by sending commands to an autopilot on the device, if the device is not sufficiently close.

4. The method of claim 1, in which the indirect control link back to the ground station includes flight data from the device, such as engine data and artificial horizon data.

5. The method of claim 1, in which the indirect position data link back to the ground control station utilizes components on the device that are isolated from the components used to provide the indirect control link.

6. The method of claim 1, in which at any time, in normal operation, there are two independent uplinks to the device, namely the direct radio link and the indirect control link; and there are two independent downlinks, namely the indirect control link and the indirect position data link, each providing redundancy for enhanced safety.

7. (canceled)

8. The method of claim 1, in which the device includes an autopilot that can continue to operate the device even if communications on all uplinks to the device cease operating, and is configured to autonomously cease its planned operation if it determines that it has exceeded a predetermined period of time or is likely to enter a restricted area or otherwise constitute a hazard or danger.

9. The method of claim 1, in which the or each ground control station includes an antenna.

10. The method of claim 1, in which the or each ground control station functions also as a control centre where one or more pilots are based.

11. The method of claim 1, in which one or more ground control station functions do not operate as a control centre where one or more pilots are based.

12. The method of claim 1, in which one or more control centres send and receive data to the device using an internet or other data connection to one or more satellite ground stations that send data to and receive data from the low earth orbit satellites.

13-37. (canceled)

38. The method of claim 5 in which the isolated components include GPS or other satellite-based position receiver or ADSB transponder and/or battery supply.

39. The method of claim 1 in which the indirect control link and indirect position link use different GPS signals and/or different satellite protocols

40. A system for controlling a pilotless device, such as a RPA, the system comprising a pilotless device, such as a RPA, a ground control station and control centre(s), in which the device is configured to use the following independent data links that provide multiple, redundant data channels:
(a) a direct radio link with the ground control station, configured to receive command signals that enable a pilot to issue commands to an autopilot in the device or have direct flight control over the device;
(b) an indirect control link with the ground control station, a different ground control station or another form of control centre, the control link being via satellites, such as low earth orbit satellites, and being configured to send command signals to the device and to send back flight information and position data from a GPS or other satellite-based position receiver in the device;
(c) an indirect position data link back to the control centre(s), the position link being via satellites, such as low earth orbit satellites, and being configured to send position data from a GPS or other satellite-based position receiver in the device;
and in which the device includes an autopilot that can continue to operate the device even if communications on all uplinks, namely the direct radio link and the indirect control link, to the device cease operating.
